(19) United States
(12) Patent Application Publication
(10) Pub. No.: US 2008/0017043 A1
(43) Pub. Date: Jan. 24, 2008

(54) Tea Stick Brewing Package and Method

(75) Inventor: Michael Gerard O'Brien, Hertfordshire (GB)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/554,149

(22) Filed: Oct. 30, 2006

Related U.S. Application Data
(60) Provisional application No. 60/803,651, filed on Jun. 1, 2006.

(51) Int. Cl. A47J 31/00

(52) U.S. Cl. 99/287; 99/290

(57) ABSTRACT

A brew stick for brewing a measure of brewable material. The brew stick may include a bag with the measure of brewable material positioned therein and a plate. The plate may include a pair of wings and a central tab. The bag is connected to the central tab such that the bag can be raised within the wings.

### RELATED APPLICATIONS

The present application is a non-provisional application claiming priority of provisional application Ser. No. 60/803,651, filed on Jun. 1, 2006, incorporated herein by reference in full.

### TECHNICAL FIELD

The present application relates generally to brewing packages and methods and more particularly relates to the use of a “tea stick” brewing package and methods for tea leaves.

### BACKGROUND OF THE INVENTION

Individual servings of tea leaves are generally packaged in a traditional double-chambered tea bag. As is well known, the tea bag is placed within a consumer's cup and the beverage is steeped until brewed. The tea bag is then removed via an attached string and discarded. Known tea bags, however, have several disadvantages. For example, traditional tea bags may not be able to fit in all types of glasses such as a traditional tulip-shaped “ince belli” Turkish tea glass and otherwise, Further, tea bags often may drip hot or boiling water when removed from the cup. Such dripping thus may present a potential danger to the consumer.

There is a desire, therefore, for an improved tea brewing system that is easy to use and also easy to be disposed of without risk of harm to the customer. The improved brewing system preferably should be reasonably priced as compared to traditional tea bags.

### SUMMARY OF THE INVENTION

The present application thus describes a brew stick for brewing a measure of brewable material. The brew stick may include a bag with the measure of brewable material positioned therein and a plate. The plate may include a pair of wings and a central tab. The bag is connected to the central tab such that the bag can be raised within the wings.

The plate may include a number of perforations positioned about the central tab such that the central tab is removable from the pair of wings. The plate may include a number of attachment tabs positioned about the central tab and the pair of wings. The brew stick further may include an envelope to seal the brew stick therein. The bag may be made out of Nylon or Soilon. The plate may be made out of cardboard. The bag may include an extended shape. The brewable material may be tea leaves.

The present application further describes a method of brewing tea in a cup from a tea stick having a tea bag attached to a plate with a central tab and a number of wings. The method may include placing the tea stick within the cup, steeping the tea, removing the tea stick from the cup, detaching the central tab from the plate, raising the tea bag between the wings, and squeezing the wings.

The method further may include the step of flattening the wings before the placing step. The placing step may include placing the tea stick in a Turkish tea glass. The placing step also may include covering the mouth of the cup with the plate. The central tab may be connected to the plate via a number of perforations and the detaching step may include ripping the number of attachments.

The present application further describes a tea stick for brewing a measure of tea leaves. The tea stick may include an extended tea bag with the measure of tea leaves positioned therein and a circular plate. The circular plate may include a pair of wings and a central tab. The tea bag is connected to the central tab via a number of perforations such that the tea bag can be raised within the wings.

The circular plate may include a number of attachment tabs positioned about the central tab and the pair of wings. The tea stick further may include an envelope to seal the tea stick therein. The tea bag may be made out of Nylon or Soilon. The plate may be made out of cardboard.

These and other features of the present application will become apparent to one of ordinary skill in the art upon review of the following detail description when taken in conjunction with the drawings and the appended claims.

### BRIEF DESCRIPTION OF THE DRAWINGS

FIG. 1 is a perspective view of a tea stick as is described herein.

FIG. 2 is an exploded view of the tea stick of FIG. 1.

FIG. 3 is a perspective view of the tea stick positioned within an envelope.

FIG. 4 is a perspective view of the tea stick being removed from the envelope.

FIG. 5 is a perspective view of the tea stick in the folded position.

FIG. 6 is a perspective view of the wings of the tea stick being opened.

FIG. 7 is a perspective view of the wings of the tea stick in the opened position.

FIG. 8 is a perspective view of the tea stick being placed in a glass.

FIG. 9 is a perspective view of the tea stick within a glass.

FIG. 10 is a perspective view of the tea stick being removed from a glass.

FIG. 11 is a perspective view of the wings of the tea stick being folded downward while the tab is being removed from the wings.

FIG. 12 is a perspective view of the tea bag being raised into the wings and the tea bag being squeezed.

FIG. 13 is a perspective view of the tea stick after use.

FIG. 14 is a perspective view of a brewed tea beverage.

### DETAILED DESCRIPTION

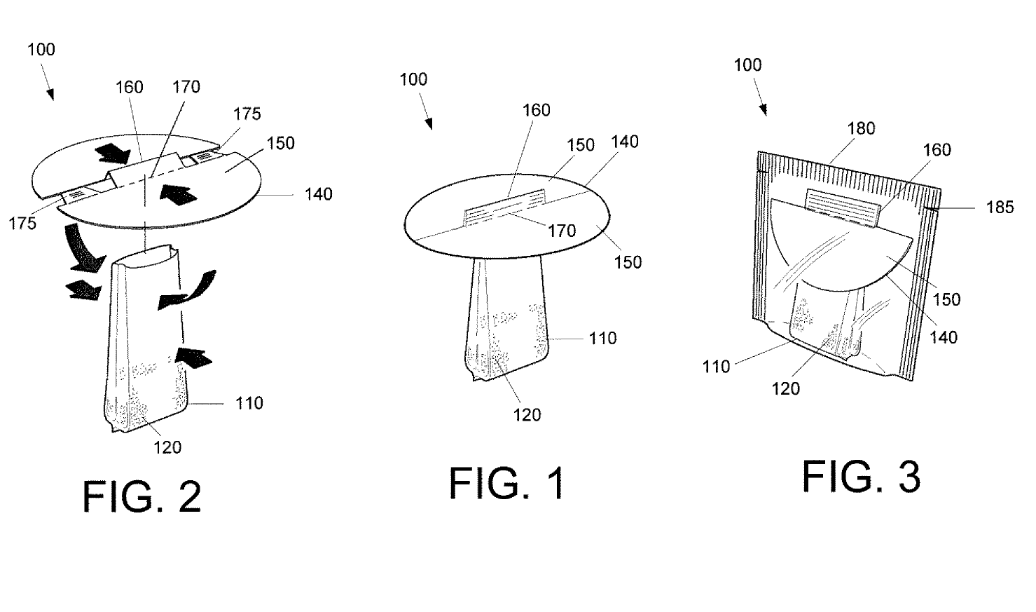

Referring now to the drawings, in which like numerals refer to like elements throughout the several views, FIGS. 1 and 2 show a tea stick 100 as is described herein. The tea stick 100 as shown is a single serving size, although other sizes may be used herein. The tea stick 100 includes a tea bag 110 with a measure of tea leaves 120 positioned therein. The tea bag 110 may have any convenient size or shape. For example, the tea bag 110 may have a width such that it will fit within an opening of a traditional tulip-shaped tea glass or other desired shape. As such, the tea bag 110 as shown has an extended shape in length. The tea bag 110 may be a single or double chamber bag. The tea bag 110 may be made out of Nylon, Soilon (a corn starch derivative), or other types of conventional materials. Any desired amount or type of tea leaves 120 may be used herein. The tea leaves 120 also may be placed within a separate pouch (not shown) before being placed within the tea bag 110. Other types of brewable material, such as coffee, may be used herein.

The tea bag 110 may be attached to a plate 140. The plate 140 may be largely circular in shape. The plate 140 may be sized to cover the open diameter of a particular type of cup. Likewise, plates 140 with a number of different shapes or sizes may be used. Specifically, the plate 140 may have any desired size or shape such that the plate 140 serves as an envelope for the tea bag 110 as will be described in more detail below. The plate 140 may be made out of paper, cardboard, plastic, and other conventional types of materials. A foil layer or another type of substantially non-permeable material also may be used thereon.

The plate 140 may be divided into two sides or “wings” 150 on either end of an extended tab 160. The tab 160 may be folded about the middle and have a number of perforations 170 on both sides along the intersection with the wings 150 so as to be detachable therefrom. The wings 150 may be detached from each other on either side of the tab 160 other than along a pair of attachment tabs 175. The elements of the plate 140 may be die cut from a continuous sheet of material. Any similar structure or manufacturing technique may be used herein. The tea bag 110 may be attached to the tab 160 of the plate 140 via heat sealing, adhesives, or other conventional types of joinder methods.

As is shown in FIG. 3, the tea stick 100 may be positioned within an envelope 180 and sealed therein. The envelope 180 may be made out of any type of conventional substantially non-permeable material. The envelope 180 may have any desired size and shape. The envelope 180 may have a tear notch 185 on one end thereof for easy opening. The envelope 180 allows the tea stick 100 to be distributed while keeping the tea leaves 120 sealed and fresh therein. Other conventional types of packaging methods may be used herein. For example, multiple tea sticks 100 may be packaged in any type of a substantially airtight container or otherwise.

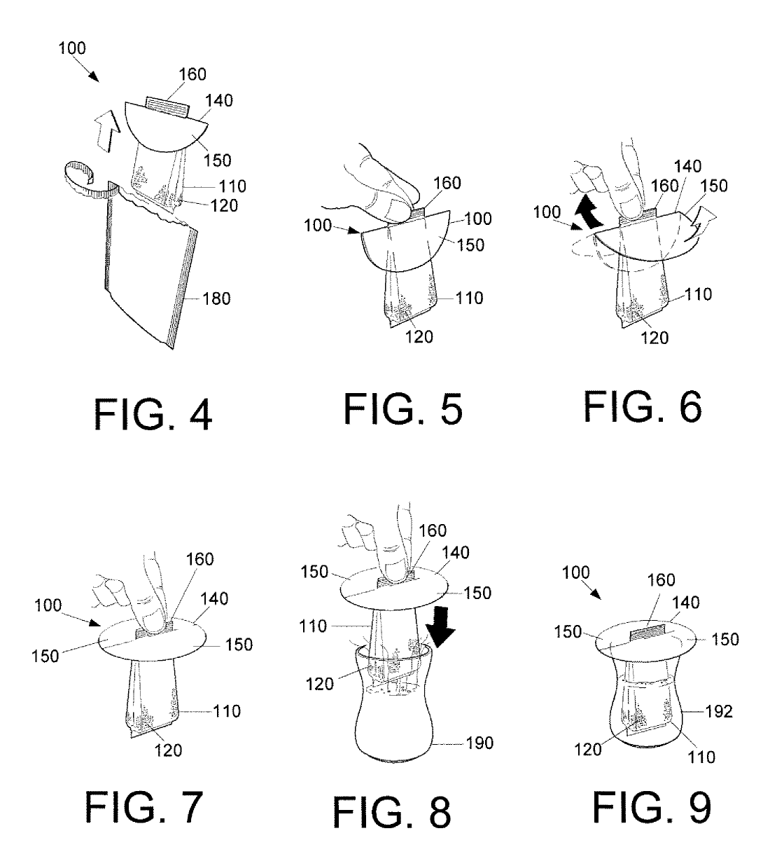

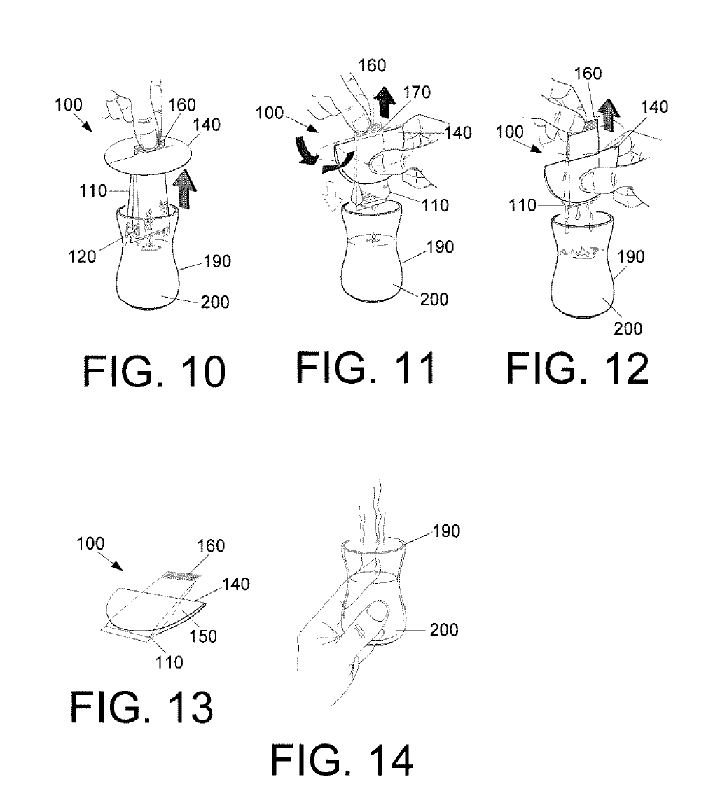

FIGS. 4-14 show use of the tea stick 100. FIG. 4 shows the tea stick 100 in its closed position while being removed from the envelope 180. As is shown in FIG. 5, the wings 150 of the tea stick 100 are folded down while in the envelope 180. In order to use the tea stick 100, the wings 150 are opened to the flat position as shown in FIGS. 6 and 7. FIG. 8 shows placing the tea stick 100 within a glass 190. In this case, the glass 190 is a tulip-shaped traditional “ince belli” Turkish tea glass. The tea stick 100 may be used with a glass 190 of any type, shape, or size. The wings 150 extend over the mouth of the glass 190 so as to keep the heat within the glass 190 and to provide for better infusion. The tea stick 100 remains in the glass 190 until the desired color or strength is reached as is shown in FIG. 9. At that point, the tea stick 100 may be removed from the glass 190 as is shown in FIG. 10.

As the tea stick 100 is being removed from the glass 190, the perforations 170 of the tab 160 are broken as the wings 150 are folded downward about the tea bag 110. As is shown in FIGS. 11 and 12, the tab 160 and the attached tea bag 110 are then pulled upward such that the wings 150 enclose the tea bag 110. The tea bag 110 then may be squeezed to remove the liquid therein without fear of the consumer contacting the hot water, The tea stick 100 also may be placed on a table as is shown in FIG. 13 without fear that the tea bag 110 will leak. Once the tea stick 100 is removed, a brewed tea beverage 200 is ready to drink.

It should be apparent that the foregoing relates only the preferred embodiments of the present application and that numerous changes and modifications may be made herein by one of ordinary skill in the art without departing from the general spirit and scope of the invention as defined by the following several claims and the equivalents thereof.

1. A brew stick for brewing a measure of brewable material, comprising:
a bag with the measure of brewable material positioned therein; and
a plate;
the plate comprising a pair of wings and a central tab;
wherein the bag is connected to the central tab such that the bag can be raised within the wings.

2. The brew stick of claim 1, wherein the plate comprises a plurality of perforations positioned about the central tab such that the central tab is removable from the pair of wings.

3. The brew stick of claim 1, wherein the plate comprises a plurality of attachment tabs positioned about the central tab and the pair of wings.

4. The brew stick of claim 1, further comprising an envelope to seal the brew stick therein.

5. The brew stick of claim 1, wherein the bag comprises Nylon or Soilon.

6. The brew stick of claim 1, wherein the plate comprises a cardboard.

7. The brew stick of claim 1, wherein the bag comprises an extended shape.

8. The brew stick of claim 1, wherein the brewable material comprises tea leaves.

9. A method of brewing tea in a cup from a tea stick having a tea bag attached to a plate with a central tab and a number of wings, comprising:
placing the tea stick within the cup;
steeping the tea;
removing the tea stick from the cup;
detaching the central tab from the plate;
raising the tea bag between the number of wings; and
squeezing the number of wings.

10. The method of claim 9, further comprising the step of flattening the number of wings before the placing step.

11. The method of claim 9, wherein the placing step comprises placing the tea stick in a Turkish tea glass.

12. The method of claim 9, wherein the placing step comprises covering the mouth of the cup with the plate.

13. The method of claim 9, wherein the central tab is connected to the plate via a number of perforations and wherein the detaching step comprising ripping the number of attachments.

14. A tea stick for brewing a measure of tea leaves, comprising:
an extended tea bag with the measure of tea leaves positioned therein; and
a circular plate;
the circular plate comprising a pair of wings and a central tab;
wherein the tea bag is connected to the central tab and the central tab is connected to the wings via a plurality of perforations such that the central tab and the tea bag can be raised within the wings.

15. The tea stick of claim 14, wherein the circular plate comprises a plurality of attachment tabs positioned about the central tab and the pair of wings.

16. The tea stick of claim 14, further comprising an envelope to seal the tea stick therein.

17. The tea stick of claim 14, wherein the tea bag comprises Nylon or Soilon.

18. The tea stick of claim 14, wherein the plate comprises a cardboard.
